(19) United States
(12) Patent Application Publication
(10) Pub. No.: US 2014/0032235 A1
(43) Pub. Date: Jan. 30, 2014

(54) CENTRALIZED PRINT METHOD, PRINTER CONTROLLER AND SYSTEM

(71) Applicant: GE MEDICAL SYSTEMS GLOBAL TECHNOLOGY COMPANY, Waukesha, WI (US)

(72) Inventors: Nan Zhou, Beijing (CN); Zhiyong Peng, Beijing (CN); Shizhen Gou, Beijing (CN)

(73) Assignee: GE MEDICAL SYSTEMS GLOBAL TECHNOLOGY COMPANY, Waukesha, WI (US)

(21) Appl. No.: 13/953,112

(22) Filed: Jul. 29, 2013

(30) Foreign Application Priority Data
Jul. 30, 2012 (CN) 201210265811.5

(51) Int. Cl. G06F 19/00; G06Q 50/22

(52) U.S. Cl. CPC G06F 19/321; G06Q 50/22
USPC 705/2

(57) ABSTRACT

A method, a printer controller, and a system for centralized print of film printing tasks and paper printing tasks, the method for centralized print comprising: receiving a film printing task and a paper printing task; identifying an identity of the film printing task; matching the film printing task and the paper printing task based on the identified identity; and printing the matched film printing task and paper printing task in response to a user's request.

### TECHNICAL FIELD

The present invention relates to the printing field, and in particular, to a method, a printer controller, and a system for centralized print of film printing tasks and paper printing tasks.

### BACKGROUND

Printing the patients' radiological examination images and examination reports is a part of the radiological examination workflow in a medical institution.

Typically, in the existing radiological examination workflow of a medical institution equipped with medical facilities and information systems in conformity with the criteria of Digital Imaging and Communication in Medicine (DICOM), a clinical diagnostician prescribes radiological examination for a patient according to the diagnosis of the patient. Then the patient goes to the department of radiology in the medical institution for radiological examination by a radiologist. After the radiological examination, the radiologist prints a digital radiological examination image of the patient on a film printer and uploads the digital radiological examination image to the server of the Picture Archiving and Communication Systems (PACS) according to the DICOM standards. A diagnostician of the department of radiology then uses the digital radiological examination image stored on the PACS server to make a diagnosis report, and prints the resulting diagnosis report on a paper printer, and at the same time stores the diagnosis report on the server of the Radiology Information System (RIS). Medical personnel such as a nurse can get a great number of radiological examination films and a great number of diagnosis reports from the department of radiology, and match the radiological examination film and the diagnosis report of the patient according to his/its registry information and diagnosis sequence number on the radiological examination film and the diagnosis report, so as to be given to the patient when he/she fetches.

The existing radiological examination workflow has the following defects.

Firstly, DICOM film printers and examination report printers are set at different positions of the department of radiology in a medical institution. It will greatly reduce the operating efficiency of the medical institution to match the great number of radiological examination films with the corresponding examination reports thereof.

Secondly, to enable every modality or work station to print radiological examination films, it needs to connect every modality or work station to a DICOM film printer. However, it will greatly increase the cost of a medical institution to configure the DICOM film printers in the medical institution to run in parallel.

In addition, patients usually get examination reports and radiological examination films after examination. Although the radiological examination films are important to the patients, not all patients need them. For example, patients whose examination reports say normal may not demand to have the examination films to reduce the expenses thereof.

Therefore, centralized print of radiological examination films and examination reports may overcome the above defects of the existing radiological examination workflow and has no obvious impact on the existing radiological examination workflow.

### SUMMARY OF THE INVENTION

The present invention provides a method, a printer controller, and a system for centralized print of film printing tasks and paper printing tasks that can solve the problems above.

According to an embodiment of the present invention, a method for centralized print of film printing tasks and paper printing tasks is provided, the method comprising steps of: receiving a film printing task and a paper printing task; identifying an identity of the film printing task; matching the film printing task and the paper printing task based on the identified identity; and printing the matched film printing task and paper printing task in response to a user's request.

In the method according to an embodiment of the present invention, the identity of the film printing task comprises a name and/or a diagnosis sequence number of a patient. In the method according to the first aspect of the present invention, the film printing task is a DICOM image printing task, and the paper printing task is a radiological examination report printing task.

In the method according to an embodiment of the present invention, the step of receiving the paper printing task further comprises: extracting an identity from the paper printing task; and storing the extracted identity and the paper printing task together in a paper printing task sequence.

In the method according to an embodiment of the present invention, the step of identifying an identity of the film printing task comprises: using an Optical Character Recognition (OCR) technology to identify the identity of the film printing task from the film printing task; and storing the film printing task and the identified identity thereof together in a film printing task sequence.

In the method according to an embodiment of the present invention, the step of receiving the film printing task further comprises: recording a receiving time of the film printing task; and storing the recorded receiving time in the film printing task sequence.

In the method according to an embodiment of the present invention, the step of identifying an identity of the film printing task comprises: artificially identifying the identity of the film printing task and replacing an OCR identified identity with the artificially identified identity when a difference of the receiving time of the film printing task in the film printing task sequence from the current time exceeds a predetermined threshold.

In the method according to an embodiment of the present invention, the step of matching the film printing task and the paper printing task based on the identified identity comprises: searching for the paper printing task having an identity matching the identity of the film printing task in the paper printing task sequence according to the identity of the film printing task, and/or searching for the film printing task having an identity matching the identity of the paper printing task in the film printing task sequence according to the identity of the paper printing task; and storing the film printing task and the paper printing task that match in identity together in a matching task sequence, and deleting the film printing task and the paper printing task that match in identity from the film printing task sequence and the paper printing task sequence.

The method according to an embodiment of the present invention further comprises updating a print state of the film printing task and the paper printing task after printing the matched film printing task and paper printing task, and deleting the printed film printing task and paper printing task from the matching task sequence.

According to an embodiment of the present invention, a printer controller for centralized print of film printing tasks and paper printing tasks is provided, the printer controller comprising: a receiving module for receiving a film printing task and a paper printing task; an identifying module for identifying an identity of the film printing task; a matching module for matching the film printing task and the paper printing task based on the identified identity; and a printing module for printing the matched film printing task and paper printing task in response to a user's request.

In the printer controller according to an embodiment of the present invention, the identity of the film printing task comprises a name and/or a diagnosis sequence number of a patient.

In the printer controller according to an embodiment of the present invention, the film printing task is a DICOM image printing task, and the paper printing task is a radiological examination report printing task.

In the printer controller according to an embodiment of the present invention, the receiving module is further configured to extract an identity from the paper printing task, and to store the extracted identity and the paper printing task together in a paper printing task sequence of a memory.

In the printer controller according to an embodiment of the present invention, the identifying module comprises: an Optical Character Recognition (OCR) module configured to use an Optical Character Recognition (OCR) technology to identify the identity of the film printing task from the film printing task, and to store the film printing task and the identified identity thereof together in a film printing task sequence of the memory.

In the printer controller according to an embodiment of the present invention, the receiving module is further configured to record a receiving time of the film printing task, and to store the recorded receiving time in the film printing task sequence of the memory.

In the printer controller according to an embodiment of the present invention, the identifying module further comprises: an artificial identifying module configured to artificially identify the identity of the film printing task and replace an OCR identified identity with the artificially identified identity when a difference of the receiving time of the film printing task in the film printing task sequence from the current time exceeds a predetermined threshold.

In the printer controller according to an embodiment of the present invention, the matching module is further configured to: search for a paper printing task having an identity matching the identity of the film printing task in the paper printing task sequence according to the identity of the film printing task, and/or search for the film printing task having an identity matching the identity of the paper printing task in the film printing task sequence according to the identity of the paper printing task; and store the film printing task and the paper printing task that match in identity together in a matching task sequence, and delete the film printing task and the paper printing task that match in identity from the film printing task sequence and the paper printing task sequence.

In the printer controller according to an embodiment of the present invention, the printing module is further configured to: update a print state of the film printing task and the paper printing task after printing the matched film printing task and paper printing task; and delete the printed film printing task and paper printing task from the matching task sequence.

According to an embodiment of the present invention, a system for centralized print of film printing tasks and paper printing tasks is provided, the system comprising: a printer controller; a Radiology Information System (RIS) server, a modality console or a PACS workstation, a print workstation, paper printers and film printers coupled to the printer controller; wherein the printer controller comprises: a receiving module for receiving a film printing task from the modality console or the PACS workstation and a paper printing task from the RIS server; an identifying module for identifying an identity of the film printing task; a matching module for matching the film printing task and the paper printing task based on the identified identity; and a printing module for printing the matched film printing task and paper printing task in response to a user's request from the print workstation.

In the system according to an embodiment of the present invention, the identity of the film printing task comprises a name and/or a diagnosis sequence number of a patient.

In the system according to an embodiment of the present invention, the film printing task is a DICOM image printing task, and the paper printing task is a radiological examination report printing task.

In the system according to an embodiment of the present invention, the receiving module in the printer controller is further configured to extract an identity from the paper printing task, and to store the extracted identity and the paper printing task together in a paper printing task sequence of a memory.

In the system according to an embodiment of the present invention, the identifying module in the printer controller comprises: an Optical Character Recognition (OCR) module configured to use an Optical Character Recognition (OCR) technology to identify the identity of the film printing task from the film printing task, and to store the film printing task and the identified identity thereof together in a film printing task sequence of the memory.

In the system according to an embodiment of the present invention, the receiving module in the printer controller is further configured to record a receiving time of the film printing task, and to store the recorded receiving time in the film printing task sequence of the memory.

In the system according to an embodiment of the present invention, the identifying module in the printer controller further comprises: an artificial identifying module configured to artificially identify the identity of the film printing task and replace an OCR identified identity with the artificially identified identity when a difference of the receiving time of the film printing task in the film printing task sequence from the current time exceeds a predetermined threshold.

In the system according to an embodiment of the present invention, the matching module in the printer controller is further configured to: search for a paper printing task having an identity matching the identity of the film printing task in the paper printing task sequence according to the identity of the film printing task, and/or search for the film printing task having an identity matching the identity of the paper printing task in the film printing task sequence according to the identity of the paper printing task; and store the film printing task and the paper printing task that match in identity together in a matching task sequence, and delete the film printing task and the paper printing task that match in identity from the film printing task sequence and the paper printing task sequence.

In the system according to an embodiment of the present invention, the printing module in the printer controller is further configured to: update a print state of the film printing task and the paper printing task in the RIS server via an RIS interface module after printing the matched film printing task and paper printing task; and delete the printed film printing task and paper printing task from the matching task sequence.

The method, printer controller, and system for centralized print of film printing tasks and paper printing tasks according to embodiments of the present invention can achieve a seamless integration of the centralized print of radiological examination images and examination reports with the conventional radiological examination workflow. Personnel in medical institutions do not need to change their conventional working path. All facilities or PACS workstations in conformity with the DICOM standards can adopt the centralized print method according to the present invention without making any obvious change. With the centralized print method of the present invention, a medical institution can enable various facilities and PACS workstations to share the DICOM film printers and paper printers without considerably increasing the costs. In addition, the various facilities and PACS workstations adopting the DICOM standards in the medical institution can adopt the centralized print method according to the present invention without making any change.

### BRIEF DESCRIPTION OF THE DRAWINGS

Some exemplary embodiments of the present invention are specifically described hereunder in combination with the figures. The same or similar elements in the figures are represented with the same reference numerals. In the figures:

FIG. 1 illustrates a structure diagram of a centralized print system according to an exemplary embodiment of the present invention;

FIG. 2 illustrates a structure diagram of an exemplary embodiment for a printer controller in the centralized print system shown in FIG. 1; and

FIG. 3 illustrates a flowchart of a method for centralized print of film printing tasks and paper printing tasks according to an exemplary embodiment of the present invention.

### DETAILED DESCRIPTION OF THE INVENTION

In the detailed description below, some exemplary embodiments of the present invention are described with reference to the figures. Persons skilled in the art will understand that the present invention is not limited to these exemplary embodiments.

At present, the DICOM standards have become the only image communication/correspondence criteria of international medical imaging devices. Using the DICOM standards is the basis of medical image communication between medical institutions and medical image international communication, e.g., to achieve undamaged image transmission and communication in remote consultation. In the meantime, with a uniform image criterion, a medical institution can archive, store and inquire medial images uniformly, thereby actualizing a filmless medical institution, saving plentiful manpower and fund, and effectively promoting the image and rank of the medical institution. From the perspective of patients, waiting time can be considerably shortened in a medical institution equipped with medical facilities and information systems in conformity with the DICOM criteria. The several processes of diagnosis, photography and report can now be completed only once in a medical institution. From the perspective of doctors, they can conveniently obtain various image data on the DICOM data bank for research and reference, and rapidly obtain images of an emergency patient, thereby winning precious time for saving the patient.

However, as stated above, in the existing radiological examination workflow of a medical institution equipped with medical facilities and information systems in conformity with the DICOM criteria, radiological examination film printers (i.e., DICOM printers) and examination report printers are set at different positions of the department of radiology in the medical institution. It needs professional staff such as nurses to match the numerous printed films and examination reports with each other according to the identity information of patients, which will lower the operating efficiency of the medical institution.

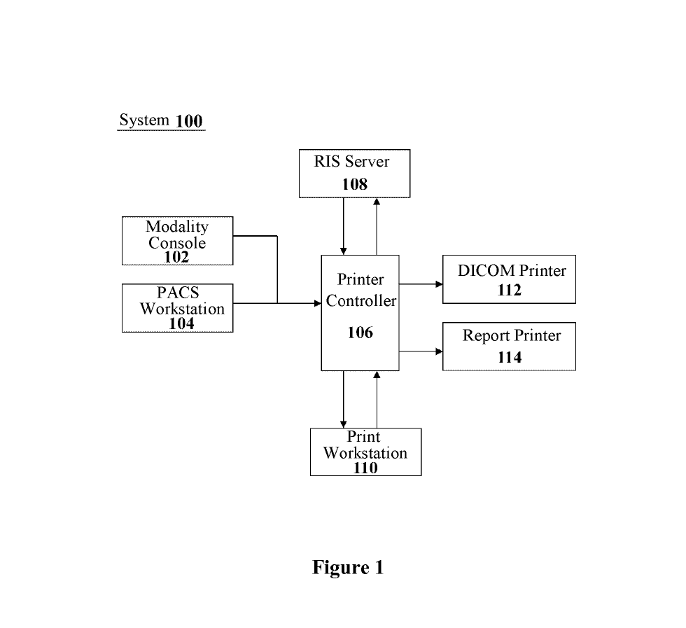

FIG. 1 illustrates a structure diagram of a centralized print system 100 according to an exemplary embodiment of the present invention.

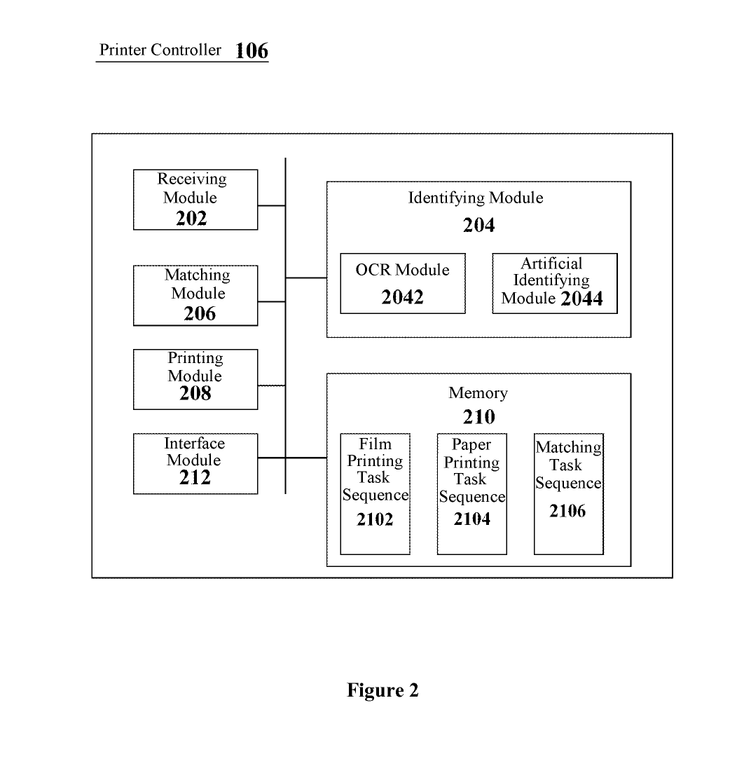

FIG. 2 illustrates a structure diagram of an exemplary embodiment for a printer controller 106 in the centralized print system 100 shown in FIG. 1.

As shown in FIG. 1, the system 100 comprises a printer controller 106, and a modality console 102, a PACS workstation 104, a Radiology Information System (RIS) server 108, a print workstation 110, one or more DICOM film printers 112, and one or more DICOM paper printers 114 coupled directly or indirectly to the printer controller 106.

The Radiology Information System (RIS) is a management system for registry, triage and image diagnosis reports of the department of radiology and for inquiry, statistics, etc. of various information of the department of radiology. Patients can book radiological examination via the RIS system which can arrange visit time and places for those with appointments. A diagnostician of the department of radiology may log on the RIS server 108 via an RIS client (not shown) to arrange the radiological examination subjects and time for a patient, and invoke the patient's radiological examination image to make a radiological examination diagnosis report and store it on the RIS server 108 after the patient undergoes the radiological examination.

The patient goes to the department of radiology for radiological examination according to the checklist prescribed by the clinical diagnostician. After performing the radiological examination on the patient, the radiologist processes the image collected by an imaging device and labels the patient's registry information and diagnosis sequence number around the digital radiological examination image, then uploads the radiological examination image in conformity with the DICOM standards to the PACS server (not shown), and can browse the DICOM image saved on the PACS server via the PACS workstation 104. The radiologist can also request printing the patient's radiological examination image, i.e., the DICOM image, on the DICOM printer 112 via the modality console 102 or the PACS workstation 104.

When the radiologist requests printing the patient's DICOM image, the modality console 102 or the PACS workstation 104 sends a DICOM image printing task to the printer controller 106, rather than sends the DICOM image printing task directly to the DICOM film printer 112.

The diagnostician of the department of radiology uses the patient's identity information, e.g., the patient's name and/or the patient's diagnosis sequence number, via the RIS client to invoke the patient's DICOM image to make the patient's diagnosis report, then stores the resulting diagnosis report on the RIS server 108 via the RIS client. The diagnostician of the department of radiology can also request printing the patient's diagnosis report via the RIS client. When the diagnostician of the department of radiology requests printing the patient's diagnosis report on the examination report paper printer 114, the RIS server 108 sends a diagnosis report printing task to the printer controller 106, rather than sends an examination report printing task directly to the paper printer 114.

As the diagnosis report includes the patient's information and diagnosis sequence number of a text format, when a receiving module 202 in the printer controller 106 receives the diagnosis report printing task from the RIS server 108, it can directly extract the patient's identity information, e.g., the patient's name and/or diagnosis sequence number, from the diagnosis report printing task as the identity of the diagnosis report printing task, and stores the extracted identity together with the diagnosis report printing task in the printer controller 106 or in a paper printing task sequence 2104 of a memory 210 coupled to the printer controller 106.

Different from the identity information including the patient's information and diagnosis sequence number of a text format in the diagnosis report printing task, an Information Object Definition (IOD) of the DICOM image printing task does not include the patient's identity information. Hence, after the receiving module 202 in the printer controller 106 receives the DICOM image printing task, it needs to extract the patient's identity information from the received DICOM image. Therefore, the receiving module 202 transmits the received DICOM image to an identifying module 204 in the printer controller 106 to extract the patient's identity information therefrom as the identity of the DICOM image printing task. To meet the requirement of the DICOM standards, the receiving module 202 may be configured according to DICOM Print SCP (Service Class Provider).

The identifying module 204 comprises an OCR module 2042 and an artificial identifying module 2044. The OCR module 2042 may employ the OCR technology to extract the patient's identity information, e.g., the patient's name and/or diagnosis sequence number, from the DICOM image as the identity of the DICOM image printing task, and stores the extracted identity information together with the DICOM image in a film printing task sequence 2102 of the memory 210.

Besides, the receiving module 202 can also be configured to record the receiving time of the film printing task and the diagnosis report printing task, and store the recorded receiving time together with the corresponding film printing task and paper printing task in the film printing task sequence 2102 and the paper printing task sequence 2104.

In one exemplary embodiment, when the receiving module 202 receives a diagnosis report printing task from the RIS server 108, it sends a triggering signal to a matching module 206 in the printer controller 106 to enable the matching module 206 to search for a film printing task having an identity matching the identity of the diagnosis report printing task in the film printing task sequence 2102 according to the identity extracted from the diagnosis report printing task.

In another exemplary embodiment, after identifying the identity of the film printing task from the film printing task, the OCR module 2042 sends a triggering signal to the matching module 206 to enable the matching module 206 to search for a paper printing task having an identity matching the identity of the film printing task in the paper printing task sequence 2104 according to the identity of the film printing task.

The matching module 206 may determine the film printing task and the paper printing task with the same diagnosis sequence number and/or patient's name to match in identity, and store the film printing task and paper printing task that match in identity together in a matching task sequence 2106 of the memory 210, and in the meantime delete the film printing task and paper printing task that match in identity from the film printing task sequence 2102 and the paper printing task sequence 2104.

To improve the accuracy of OCR identification, when labeling the patient's registry information and diagnosis sequence number on the digital radiological examination image, the radiologist shall avoid as much as possible overlapping the labeled registry information and diagnosis sequence number with the radiological examination image.

Since the OCR identification cannot guarantee 100% accuracy, after a period of time, there might be a few unmatched film printing tasks and paper printing tasks in the film printing task sequence 2102 and the paper printing task sequence 2104.

Hence, in one exemplary embodiment, the matching module 206 can also be configured to periodically compare the receiving time of the film printing tasks in the film printing task sequence 2102 with the current time. If their difference exceeds a predetermined threshold, the matching module 206 sends a triggering signal to the artificial identifying module 2044 in the identifying module 204 to put the artificial identifying module 2044 into service. The predetermined threshold can be set by the medical institution in accordance with the time-limit requirement for a diagnostician of the department of radiology to issue an examination and diagnosis report in combination with the time-limit requirement for a patient to fetch the report. For example, if the medical institution requires the diagnostician of the department of radiology to make a diagnosis report within 12 hours after the DICOM image is uploaded and promises the patient to fetch the report in 24 hours after examination, the predetermined threshold can be set to be, e.g., 13 to 20 hours.

After the artificial identifying module 2044 is put into service, the printer controller 106 may present the unmatched film printing tasks and/or paper printing tasks to a user such as a nurse on the print workstation 110 coupled to the printer controller 106 via an interface module 212 thereof, such that the user can browse the film printing tasks to artificially identify the identities thereof and input the artificially identified identities into the print workstation 110 via an input device of the print workstation 110. In one embodiment, the print workstation 110 conveys the artificially identified identities to the artificial identifying module 2044 of the printer controller 106, such that the artificial identifying module 2044 can replace the identities of the corresponding film printing tasks in the film printing task sequence 2102 with the artificially identified identities, and trigger the matching module 206 to search for the paper printing tasks with identities matching the artificially identified identities in the paper printing task sequence 2104 according to the artificially identified identities. Then, the matching module 206 stores the film printing tasks and paper printing tasks that match in identity together in the matching task sequence 2106 of the memory 210, and in the meantime deletes the film printing tasks and paper printing tasks that match in identity from the film printing task sequence 2102 and the paper printing task sequence 2104.

If the matching module 206 still cannot find the matched examination report printing tasks in the paper printing task sequence 2104 based on the artificially identified identities, the matching module 206 may report mistakes to a user such as a nurse and present the mistaken film printing tasks on the print workstation 110 via the interface module 212.

The printer controller 106 may further present the film printing tasks and paper printing tasks in the matching task sequence 2106 to the user such as a nurse in the form of a printing task list via the print workstation 110, such that the nurse can select corresponding printing tasks from the printing task list according to the patients' identities. In another embodiment, an independent print workstation (not shown) similar to the print workstation 110 can be provided to enable a user such as a patient to independently browse and print the corresponding printing task according to an identification code like a bar code on the pickup list.

To meet the requirement of the DICOM standards, a printing module 208 in the printer controller 106 may be configured according to DICOM Print SCU (Service Class User). After the printing module 208 receives a printing request from the user, the corresponding film printing task and paper printing task in the matching task sequence 2106 are respectively sent to the DICOM film printer 112 and the examination report printer 114, to finally print the patient's DICOM image film and the corresponding examination report. In one embodiment, the printing module 208 may also be configured to delete the printed film printing task and paper printing task from the matching task sequence 2106 after printing the matched film printing task and paper printing task in response to the user's request, and send a print update message to the RIS server via the interface module 212 for the RIS server to update the print state of the corresponding DICOM image and diagnosis report, e.g., to label the print state as “printed already”.

Persons skilled in the art shall understand that the printer controller 106 and the one or more modules therein as shown in FIG. 2 can be implemented by using software, hardware and/or firmware in accordance with practical needs. Such implementation is easily achievable to persons skilled in the art, and will not be elaborated here for the sake of brevity.

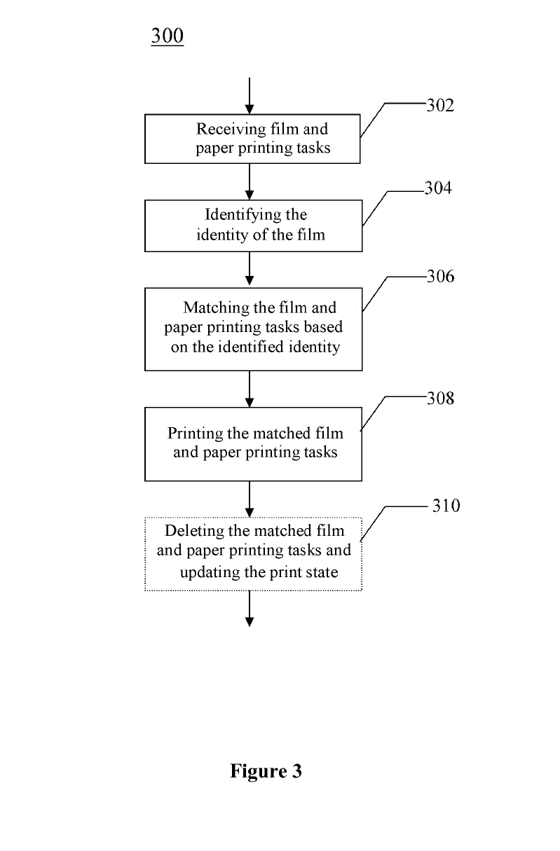

FIG. 3 illustrates a flowchart of a method 300 for centralized print of film printing tasks and paper printing tasks according to an exemplary embodiment of the present invention.

At step 302, a film printing task and a paper printing task are received, wherein the film printing task may be, for example, a DICOM image printing task from the modality console or the PACS workstation in a medical institution, while the paper printing task may be, for example, a diagnosis report printing task from the RIS server.

As the diagnosis report includes the patient's information and diagnosis sequence number in a text format, the patient's identity information, e.g., the patient's name and/or diagnosis sequence number, may be extracted from the received diagnosis report printing task as the identity of the diagnosis report printing task, and the extracted identity and the diagnosis report printing task may be stored together in the paper printing task sequence.

Different from the identity information including the patient's information and diagnosis sequence number of a text format in the diagnosis report printing task, the Information Object Definition (IOD) of the DICOM image printing task does not include the patient's identity information. Hence, after the DICOM image printing task is received, it needs to extract the patient's identity information from the received DICOM image.

When the film printing task and the paper printing task are received, the receiving time of the film printing task and the diagnosis report printing task may also be recorded, and the recorded receiving time is stored together with the corresponding film printing task and paper printing task in the film printing task sequence and the paper printing task sequence to be mentioned below.

At step 304, the identity of the received film printing task is identified. In one embodiment, the OCR technology may be employed to identify the patient's identity information, e.g., the patient's name and/or diagnosis sequence number, from the DICOM image as the identity of the film printing task, and the extracted identity information and the DICOM image are stored together in the film printing task sequence.

At step 306, the film printing task and the paper printing task are matched according to the identified identity.

In one exemplary embodiment, when a diagnosis report printing task is received, a film printing task having an identity matching the identity of the diagnosis report printing task is searched for in the film printing task sequence according to the identity extracted from the diagnosis report printing task. In another exemplary embodiment, after the identity of the film printing task is identified from the film printing task by employing the OCR technology, a paper printing task having an identity matching the identity of the film printing task is searched for in the paper printing task sequence according to the identity of the film printing task.

The film printing task and the paper printing task with the same diagnosis sequence number and/or patient's name may be considered to match in identity, and the film printing task and paper printing task that match in identity are stored together in the matching task sequence. In the meantime, the film printing task and the paper printing task that match in identity are deleted from the film printing task sequence and the paper printing task sequence.

To improve the accuracy of OCR identification, when the patient's registry information (e.g., name) and diagnosis sequence number are labeled on the digital radiological examination image (i.e., DICOM image), the labeled registry information and diagnosis sequence number shall be avoided to overlap the DICOM image as much as possible.

Since the OCR identification cannot guarantee 100% accuracy, after a period of time, there might be a few unmatched film printing tasks and paper printing tasks in the film printing task sequence and the paper printing task sequence.

Hence, in one exemplary embodiment, the receiving time of the film printing tasks in the film printing task sequence may be periodically compared with the current time. If their difference exceeds a predetermined threshold, an artificial identification mode is invoked. The predetermined threshold can be set by the medical institution in accordance with the time-limit requirement for a diagnostician of the department of radiology to issue an examination and diagnosis report in combination with the time-limit requirement for a patient to fetch the report. For example, if the medical institution requires the diagnostician of the department of radiology to make a diagnosis report within 12 hours after the DICOM image is uploaded and promises the patient to fetch the report in 24 hours after examination, the predetermined threshold can be set to be, e.g., 13 to 20 hours.

After the artificial identification mode is invoked, the unmatched film printing tasks and/or paper printing tasks are presented to a user like a nurse, such that the user can browse the film printing tasks to artificially identify the identities thereof and replace the identities of the corresponding film printing tasks in the film printing task sequence with the artificially identified identities, and search for the paper printing tasks with identities matching the artificially identified identities in the paper printing task sequence. Then, the film printing tasks and the paper printing tasks that match in identity may be stored together in the matching task sequence, and in the meantime the film printing tasks and the paper printing tasks that match in identity may be deleted from the film printing task sequence and the paper printing task sequence.

If the corresponding examination report printing task still cannot be found in the paper printing task sequence based on the artificially identified identity, the mistake shall be reported to a user like a nurse and the mistaken film printing task shall be presented to the user via the interface.

At step 308, the matched film printing task and paper printing task are printed in response to the users' request. In one embodiment, all of the film printing tasks and paper printing tasks in the matching task sequence may be presented to a user like a nurse in the form of a printing task list, such that the nurse can choose to print a corresponding printing task from the printing task list according to the patient's identity evidence. In another embodiment, a user such as a patient can independently browse and print the corresponding printing task according to an identification code like a bar code on a pickup list.

At step 308, after a user's printing request is received, the corresponding film printing task and paper printing task in the matching task sequence are respectively sent to the DICOM film printer and the examination report printer, to finally print the patient's DICOM image film and the corresponding examination report.

In one embodiment, after the matched film printing task and paper printing task are printed in response to the user's request, the printed film printing task and paper printing task may be deleted from the matching task sequence and a print update message is sent to the RIS server (step 310) such that the RIS server can update the print state of the corresponding DICOM image and diagnosis report, e.g., label the print state as “printed already”.

The method, printer controller, and system for centralized print of film printing tasks and paper printing tasks according to the present invention can achieve a seamless integration of the centralized print of radiological examination images and examination reports with the existing radiological examination workflow. Personnel in medical institutions do not need to change their conventional working path. All facilities or PACS workstations in conformity with the DICOM standards can adopt the centralized print solution according to the present invention without making any obvious change. The centralized print method of the present invention can optimize the radiological examination workflow without having obvious impact on the existing radiological examination workflow of medical institutions.

With the centralized print method of the present invention, a medical institution can enable various facilities and PACS workstations to share DICOM film printers and paper printers without considerably increasing the costs, and can automatically match the patients' DICOM images and diagnosis reports, thereby optimizing the radiological examination workflow of the medical institution and significantly improving the operating efficiency of the medical institution. In addition, the various facilities or PACS workstations adopting the DICOM standards in the medical institution can adopt the solution of centralized print of DICOM images and diagnosis reports according to the present invention without making any change.

Although the present invention has been described with reference to specific embodiments above, it is not intended that the present invention be limited to these specific embodiments. Those skilled in the art will appreciate that various modifications, substitutions and changes may be made to the present invention. For example, one step or component in the above embodiments may be implemented in plural steps or components; or conversely, functions of plural steps or components in the above embodiments may be implemented in one step or component. However, these changes should fall within the scope of protection of the present invention without departing from the spirit of the present invention. In addition, some terms as used in the specification and claims of this application are not restrictive, but to facilitate description. Furthermore, all or part of the features described in one particular embodiment can be combined in another embodiment in accordance with practical needs.

What is claimed is:

1. A method for centralized print of film printing tasks and paper printing tasks, comprising steps of:
receiving a film printing task and a paper printing task;
identifying an identity of the film printing task;
matching the film printing task and the paper printing task based on the identified identity; and
printing the matched film printing task and paper printing task in response to a user's request.

2. The method according to claim 1, wherein the identity of the film printing task comprises a name and/or a diagnosis sequence number of a patient.

3. The method according to claim 1, wherein the film printing task is a Digital Imaging and Communication in Medicine (DICOM) image printing task, and the paper printing task is a radiological examination report printing task.

4. The method according to claim 1, wherein the step of receiving the paper printing task further comprises:
extracting an identity from the paper printing task; and
storing the extracted identity and the paper printing task together in a paper printing task sequence.

5. The method according to claim 4, wherein the identifying step comprises:
using an Optical Character Recognition (OCR) technology to identify the identity of the film printing task from the film printing task; and
storing the film printing task and the identified identity thereof together in a film printing task sequence.

6. The method according to claim 4, wherein the step of receiving the film printing task further comprises:
recording a receiving time of the film printing task; and
storing the recorded receiving time in the film printing task sequence.

7. The method according to claim 6, wherein the identifying step further comprises:
identifying artificially the identity of the film printing task and replacing the OCR identified identity with the artificially identified identity when a difference of the receiving time of the film printing task in the film printing task sequence from the current time exceeds a predetermined threshold.

8. The method according to claim 5, wherein the matching step comprises:
searching for the paper printing task having an identity matching the identity of the film printing task in the paper printing task sequence according to the identity of the film printing task, and/or searching for the film printing task having an identity matching the identity of the paper printing task in the film printing task sequence according to the identity of the paper printing task; and
storing the film printing task and the paper printing task that match in identity together in a matching task sequence, and deleting the film printing task and the paper printing task that match in identity from the film printing task sequence and the paper printing task sequence.

9. The method according to claim 8 further comprising:
updating a print state of the film printing task and the paper printing task after printing the matched film printing task and paper printing task; and
deleting the printed film printing task and paper printing task from the matching task sequence.

10. A printer controller for centralized print of film printing tasks and paper printing tasks, the printer controller comprising:
a receiving module for receiving a film printing task and a paper printing task;
an identifying module for identifying an identity of the film printing task;
a matching module for matching the film printing task and the paper printing task based on the identified identity; and
a printing module for printing the matched film printing task and paper printing task in response to a user's request.

11. The printer controller according to claim 10, wherein the identity of the film printing task comprises a name and/or a diagnosis sequence number of a patient.

12. The printer controller according to claim 10, wherein the film printing task is a Digital Imaging and Communication in Medicine (DICOM) image printing task, and the paper printing task is a radiological examination report printing task.

13. The printer controller according to claim 10, wherein the receiving module is further configured to extract an identity from the paper printing task, and to store the extracted identity and the paper printing task together in a paper printing task sequence of a memory.

14. The printer controller according to claim 13, wherein the identifying module comprises:
an Optical Character Recognition (OCR) module configured to use an Optical Character Recognition (OCR) technology to identify the identity of the film printing task from the film printing task, and to store the film printing task and the identified identity thereof together in a film printing task sequence of the memory.

15. The printer controller according to claim 13, wherein the receiving module is further configured to record a receiving time of the film printing task, and to store the recorded receiving time in the film printing task sequence of the memory.

16. The printer controller according to claim 15, wherein the identifying module further comprises:
an artificial identifying module configured to artificially identify the identity of the film printing task and replace the OCR identified identity with the artificially identified identity when a difference of the receiving time of the film printing task in the film printing task sequence from the current time exceeds a predetermined threshold.

17. The printer controller according to claim 14, wherein the matching module is further configured to:
search for a paper printing task having an identity matching the identity of the film printing task in the paper printing task sequence according to the identity of the film printing task, and/or search for the film printing task having an identity matching the identity of the paper printing task in the film printing task sequence according to the identity of the paper printing task; and
store the film printing task and the paper printing task that match in identity together in a matching task sequence, and delete the film printing task and the paper printing task that match in identity from the film printing task sequence and the paper printing task sequence.

18. The printer controller according to claim 17, wherein the printing module is further configured to:
update a print state of the film printing task and the paper printing task after printing the matched film printing task and paper printing task; and
delete the printed film printing task and paper printing task from the matching task sequence.

19. A system for centralized print of film printing tasks and paper printing tasks, the system comprising:
a printer controller;
a Radiology Information System (RIS) server, a modality console or a Picture Archiving and Communication Systems (PACS) workstation, a print workstation, paper printers and film printers coupled to the printer controller;
wherein the printer controller comprises:
a receiving module for receiving a film printing task from the modality console or the PACS workstation and a paper printing task from the RIS server;
an identifying module for identifying an identity of the film printing task;
a matching module for matching the film printing task and the paper printing task based on the identified identity; and
a printing module for printing the matched film printing task and paper printing task in response to a user's request from the print workstation.

20. The system according to claim 19, wherein the identity of the film printing task comprises a name and/or a diagnosis sequence number of a patient.

21. The system according to claim 19, wherein the film printing task is a Digital Imaging and Communication in Medicine (DICOM) image printing task, and the paper printing task is a radiological examination report printing task.

22. The system according to claim 19, wherein the receiving module in the printer controller is further configured to extract an identity from the paper printing task, and to store the extracted identity and the paper printing task together in a paper printing task sequence of a memory.

23. The system according to claim 22, wherein the identifying module in the printer controller comprises:
an Optical Character Recognition (OCR) module configured to use an Optical Character Recognition (OCR) technology to identify the identity of the film printing task from the film printing task, and to store the film printing task and the identified identity thereof together in a film printing task sequence of the memory.

24. The system according to claim 22, wherein the receiving module in the printer controller is further configured to record a receiving time of the film printing task, and to store the recorded receiving time in the film printing task sequence of the memory.

25. The system according to claim 24, wherein the identifying module in the printer controller further comprises:
an artificial identifying module configured to artificially identify the identity of the film printing task and replace the OCR identified identity with the artificially identified identity when a difference of the receiving time of the film printing task in the film printing task sequence from the current time exceeds a predetermined threshold.

26. The system according to claim 22, wherein the matching module in the printer controller is further configured to:
search for a paper printing task having an identity matching the identity of the film printing task in the paper printing task sequence according to the identity of the film printing task, and/or search for the film printing task having an identity matching the identity of the paper printing task in the film printing task sequence according to the identity of the paper printing task; and
store the film printing task and the paper printing task that match in identity together in a matching task sequence, and delete the film printing task and the paper printing task that match in identity from the film printing task sequence and the paper printing task sequence.

27. The system according to claim 26, wherein the printing module in the printer controller is further configured to:
update a print state of the film printing task and the paper printing task in the RIS server via an interface module in the printer controller after printing the matched film printing task and paper printing task; and
delete the printed film printing task and paper printing task from the matching task sequence.
